(19) United States
(12) Patent Application Publication
(10) Pub. No.: US 2002/0194339 A1
(43) Pub. Date: Dec. 19, 2002

(54) Method and apparatus for allocating working and protection bandwidth in a telecommunications mesh network

(76) Inventors: Philip J. Lin, Newton, MA (US); Timothy Y. Chow, Quincy, MA (US); James D. Mills, Wilmington, MA (US)

Correspondence Address: Kenneth J. Rudofski, 1415 West Diehl Road, MS 16, Naperville, IL, 60563, US

(21) Appl. No.: 10/146,212

(22) Filed: May 15, 2002

Related U.S. Application Data
(60) Provisional application No. 60/291,433, filed on May 16, 2001.

(51) Int. Cl. G06F 15/173

(52) U.S. Cl. 709/226

(57) ABSTRACT

The present invention relates, by way of illustration, to a telecommunications network that includes a collection of geographically dispersed network elements, called nodes, connected by communication links (e.g., fiber, wireless links). The topology of the network may be an arbitrary mesh. This information may be represented by a graph. For each pair of nodes in the network, a pair of node-disjoint paths between the nodes of minimum total length is computed. One path of each pair is designated to be the working path and the other is designated to be a protection path. Each time there is a traffic demand to be routed on the network from one node A to another node B, the required amount of bandwidth to support the demand is allocated on the working path between A and B. Bandwidth is also allocated along the protection path. To determine how much protection bandwidth is needed on a particular link L, each failure scenario is simulated, the amount of bandwidth on link L would be needed for restoring traffic under that scenario is computed, and then just enough bandwidth on L to handle the worst-case failure scenario is allocated. According to an embodiment of the present invention, a computer may be used to achieve the simulation, computation, and allocation.

### RELATED APPLICATIONS

This patent application claims priority to the provisional patent application having the assigned serial No. 60/291,433 filed on May 16, 2001, entitled “METHOD AND APPARATUS FOR ALLOCATING WORKING AND PROTECTION BANDWIDTH IN A TELECOMMUNICATIONS MESH NETWORK”.

### FIELD OF THE INVENTION

The present invention relates to network protection. More specifically, the present invention relates to an optical layer mesh protection scheme.

### BACKGROUND

There exist a variety of methods of providing protection in a network such that there are backup paths for sending traffic on a network in the case of a failure. The most predominant methods are SONET protection rings (BLSR, UPSR) and mesh protection schemes.

SONET ring protection methods suffer the drawback of being wasteful in bandwidth. Having to organize the network into rings places constraints on the network architecture. Mesh protection schemes are often complicated and difficult to manage. They are also relatively new (compared with ring protection) and have not been “proven” in the fields to work accurately and speedily. The practicality of mesh protection because of its complexity, which causes either erroneous or slow operation, is still unknown.

### SUMMARY OF THE INVENTION

The present invention relates, by way of illustration, to a telecommunications network that includes a collection of geographically dispersed network elements, called nodes, connected by communication links (e.g., fiber, wireless links). The topology of the network may be an arbitrary mesh. This information may be represented by a graph. For each pair of nodes in the network, a pair of node-disjoint paths between the nodes of minimum total length is computed. One path of each pair is designated to be the working path and the other is designated to be a protection path. Each time there is a traffic demand to be routed on the network from one node A to another node B, the required amount of bandwidth to support the demand is allocated on the working path between A and B. Bandwidth is also allocated along the protection path. To determine how much protection bandwidth is needed on a particular link L, each failure scenario is simulated, the amount of bandwidth on link L would be needed for restoring traffic under that scenario is computed, and then just enough bandwidth on L to handle the worst-case failure scenario is allocated. According to an embodiment of the present invention, a computer may be used to achieve the simulation, computation, and allocation.

### DESCRIPTION OF THE DRAWINGS

The present invention is illustrated by way of example and not by way of limitation in the figures of the accompanying drawings, in which like references indicate similar elements and in which:

FIG. 1 illustrates a mesh network according to an exemplary embodiment of the present invention.

### DETAILED DESCRIPTION

A. Provisioning

1. For each source-destination pair in the network, one finds a pair of node-disjoint paths between them. One of the two paths is designated to be the working path, and the other is designated to be the protection path.

2. All working traffic from the given source to the given destination is routed along the working path.

3. Since disjoint-pair (“DP”) is a shared protection scheme rather than a dedicated protection scheme, one does not send a duplicate copy of the working traffic down the protection path. Instead, protection bandwidth is allocated, but carries no traffic (except perhaps for extra traffic) except when there is a failure. Furthermore, one allocates only the minimum amount of protection bandwidth that is required to recover from any single link failure or node failure.

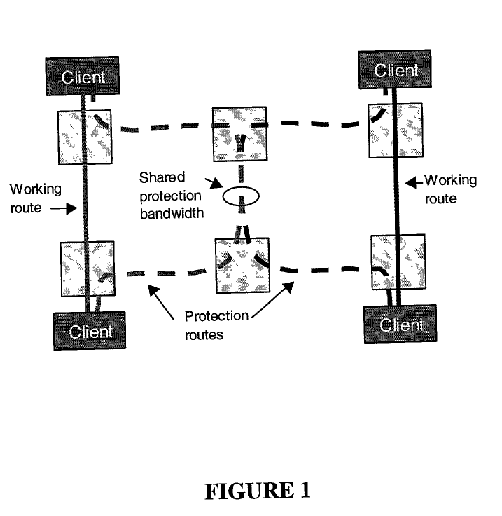

FIG. 1 illustrates an exemplary embodiment of the present invention as implemented in a network.

B. Signaling

1. When a link or a node fails, the destination will detect loss of light or loss of signal, and will send a message to the source (upstream) along the protection path.

2. Upon receiving this message, the source will send an acknowledgment (“ack”) to the destination (downstream) along the protection path and will switch the working traffic over to the protection path.

3. As each node on the protection path receives the ack, it will forward the ack, as well as choosing a protection wavelength on the next link on the path to switch the light path onto. When the destination receives the ack and makes the appropriate switch, the protection is complete.

C. Explanatory Notes

1. Remarks About Provisioning

a. Wavelength conversion is assumed to be available at every node. Thus an end-to-end lightpath may use different wavelengths on different links. It is possible to extend DP to the situation where wavelength conversion is unavailable at some (or even all) nodes. Preliminary study suggests that the absence of wavelength conversion will slightly increase the bandwidth requirement; in addition, the complexity of the network management may increase.

b. The precise amount of protection bandwidth to be allocated on each link L is computed as follows: we run through every single-link failure and every single-node failure in turn, computing how much protection bandwidth (if any) would be needed on link L for each failure scenario. Then we allocate just enough bandwidth on link L to handle the worst-case failure scenario. Note: if a node fails, then traffic that originates or terminates at that node does not need to be backed up.

c. Only the total number of protection wavelengths on each link is pre-computed; the actual assignment of wavelengths to protection light paths is not done until a failure occurs. Note that the same light path may end up using different wavelengths under different failure scenarios; therefore, pre-assigning wavelengths, which eliminates this flexibility, may slightly increase the required amount of protection bandwidth.

d. Note that the agent doing the provisioning, whether a human being, an NMS, or a control plane, needs to know a certain amount of global information about the network, in order to perform the calculations in point (b) above.

e. DP routes all traffic from a given source to a given destination along the same path. In practice this may cause certain links to become exhausted quickly, and network providers may desire the flexibility of choosing a different route for some of the working traffic. In principle there is no difficulty extending DP to accommodate this.

f. DP is a path-based protection scheme rather than a link-based protection scheme. Path-based schemes tend to be more bandwidth-efficient than link-based schemes, and they tend to handle node failures more easily. 2. Remarks About Signaling

a. Each frame has, as part of its overhead, a unique connection ID as well as some bytes for transmitting signaling information. The connection ID distinguishes the connection from all other connections in the network, including connections that share the same source and destination nodes but that travel on different fibers and/or wavelengths. If traffic is bidirectional, the two directions are given different connection ID's.

b. Each node has two tables of information. The routing table of node 1 specifies, for each connection ID whose protection path contains node 1, the upstream and downstream links for that connection. For example, if the protection path for connection 5 travels from node 1 to node 2 to node 3, then the routing table of node 2 will have an entry specifying that the upstream link for connection 5 is the link between nodes 1 and 2, and that the downstream link for connection 5 is the link between nodes 2 and 3. The wavelength table of node 1 specifies, for each link that is incident to node 1, a list of the fibers and wavelengths on each fiber that are available for routing protection traffic.

c. When there is a link failure or a node failure, the nodes downstream of the failure will detect loss of light. Each of these downstream nodes will check to see if it is the final destination of the failed light path. If it is not, then the node does not need to take action (other than perhaps generating an AIS on the failed channel). If on the other hand it is the final destination, then the node will send a message to the source upstream along the protection route for that light path, indicating a failure. Each node along the protection route will use its routing table to determine what the next hop should be.

d. When the source receives the message, it will then send an acknowledgment back down the protection route, as well as switching the working traffic onto the protection route and generating an AIS on the working route. As each node on the protection route receives the acknowledgment, it will use its routing table to determine the next hop, and it will use its wavelength table to determine an available wavelength on that next hop. The node will switch the traffic onto that wavelength, and the wavelength table will be updated accordingly.

e. The wavelength table is necessary so that if there is a second failure in a network, it will not pre-empt protection wavelengths that are in use due to the first failure. Conversely, the wavelength tables allow failures after the first to be protected if there is sufficient residual protection bandwidth.

f. One might wonder why it is not possible to save time by having the nodes on the protection path switch to a protection wavelength during the upstream propagation of the initial loss-of-light message from the destination to the source. Why wait until the source has acked before switching? The reason is that if the loss of light is caused by failure of the source node, then according to the provisioning rules, such light paths are not entitled to any protection bandwidth. But when the destination detects a failure, it does not know whether the failure occurred at the source or at an intermediate point, so if one were to reserve protection bandwidth during the upstream propagation, then one might lock up valuable protection bandwidth and block legitimate requests for that bandwidth.

g. A single link or node failure may cause many end-to-end light paths to fail. Each light path will generate its own failure signal. Thus each node 1n the network must be equipped with the ability to queue multiple signaling requests and process them in order. Notice also that the existence of several simultaneous light-path failures means that the K1/K2 signaling protocol of SONET cannot be used without major modifications.

h. It is an open question exactly how the signaling information will be propagated-in-band or out-of-band? optical supervisory channel? pilot tone? Tentatively we are assuming in-band signaling and OEO conversion at each node. Note, however, that as explained in point (f) above, some signals need to be propagated before any protection bandwidth is assigned to specific channels, so in-band signaling must be carefully designed to allow for this. In addition, if traffic is not bidirectional, then there is a potential problem with in-band signaling: there may be no upstream bandwidth available for the destination to signal the source.

i. A variation on the above-described signaling scheme would be for the destination to inform the source of a failure by flooding the network with signals, instead of propagating the signal only up the protection path. This might speed up the first part of the signaling process; however, since each node already must queue multiple signals, flooding could overload these queues and cause greater overall delay.

j. Under the current scheme, the destination is solely responsible for alerting other network elements of a failure. Therefore, if the destination fails, the other nodes, including the source, might continue to believe that everything is working fine. This problem may be solved in various ways, e.g., by keep-alive signals that the destination constantly sends to the source.

k. Mesh inter-working with drop-and-continue-like dual homing requires further signaling protocols.

In the foregoing specification the invention has been described with reference to specific exemplary embodiments thereof. It will, however, be evident that various modifications and changes may be made thereto without departing from the broader spirit and scope of the invention. For example, the provisioning embodiment described may be implemented with a signal embodiment different from that described. Similarly, the signaling embodiment described maybe implemented with a provisioning embodiment different from that described. The specification and drawings are, accordingly, to be regarded in an illustrative rather than restrictive sense.

What is claimed is:

1. A method of determining a bandwidth for a link in a mesh network, comprising:
determining a support bandwidth required to support a failure in a link in the mesh network;
determining from the support bandwidth a worst-case bandwidth; and designating the worst-case bandwidth as the bandwidth.
